(19) United States
(12) Patent Application Publication
(10) Pub. No.: US 2023/0324076 A1
(43) Pub. Date: Oct. 12, 2023

(54) AIR CONDITIONER

(71) Applicant: LG ELECTRONICS INC., Seoul (KR)

(72) Inventor: Hyeongnam YU, Seoul (KR)

(21) Appl. No.: 18/131,985

(22) Filed: Apr. 7, 2023

(30) Foreign Application Priority Data
Apr. 12, 2022 (KR) 10-2022-0045243

(51) Int. Cl. F24F 13/28; F24F 13/20; F24F 13/08

(52) U.S. Cl. CPC F24F 13/28; F24F 13/20; F24F 13/082

(57) ABSTRACT

An air conditioner is provided that may include a case; a base panel that is disposed at a first side of the case and has an inlet into which air flows; an inlet grill that is rotatably disposed in the base panel based on a first rotational shaft, and disposed at a lower side of the inlet; and a first filter that is movably or rotatably disposed in the base panel based on a second rotational shaft, and removes foreign substances in the air flowing into the inlet. The second rotational shaft of the first filter may be movably disposed in a frontward-rearward direction at an upper side of the first rotational shaft of the inlet grill.

### CROSS-REFERENCE TO RELATED APPLICATION(S)

This application claims priority under 35 U.S.C. § 119 to Korean Application No. 10-2022-0045243, filed in Korea on Apr. 12, 2022, whose entire disclosure is hereby incorporated by reference.

### BACKGROUND

### 1. Field

An air purifier, and more particularly, an air conditioner having a filter mounted in a suction port are disclosed herein.

### 2. Background

An air conditioner may provide heat-exchanged air or filtered air to an indoor space in order to make the indoor space more comfortable. The air conditioner may be installed by, for example, a floor installation method, a wall mounting method, or a ceiling mounting method according to an environment of the indoor space.

The air conditioner installed on a ceiling is difficult to manipulate because a user needs to be at a height of the ceiling in order to, for example, replace or repair a filter. In addition, when separating a plurality of components disposed in the air conditioner, it is cumbersome to individually separate each of the components. In addition, in order to separate a component disposed at an upper side among the components disposed in an upward-downward direction, it is cumbersome to remove the entire structure.

Korean Patent Publication No. 2022-0023197A, which is hereby incorporated by reference, discloses structure for separating an inlet grill of an air conditioner using a lifting grill. However, there may be space or cost limitations in such a structure, because a plurality of components are added to the inside of the air conditioner. In addition, in the structure disclosed in the above document, in order to replace a filter, for example, there is still a hassle in that the entire structure must be separated because a component, such as a suction grill, must be separated together from the entire structure of the air conditioner.

### BRIEF DESCRIPTION OF THE DRAWINGS

Embodiments will be described in detail with reference to the following drawings in which like reference numerals refer to like elements, and wherein:

FIG. 1 is a bottom perspective view of an air conditioner according to an embodiment;

FIG. 2 is a bottom view of an air conditioner according to an embodiment;

FIG. 3 is a cross-sectional view, taken along line III-III′ of FIG. 2;

FIG. 4 is a bottom view of a base panel according to an embodiment;

FIG. 5 is a cross-sectional view, taken along line IV-IV′ of FIG. 4;

FIG. 6 is a cross-sectional view of FIG. 5 to which a filter housing is added;

FIG. 7 is a bottom view of an inlet grill according to an embodiment;

FIG. 8 is a perspective view of the inlet grill according to an embodiment;

FIG. 9 is a side view of the inlet grill according to an embodiment;

FIG. 10 is a perspective view of a filter frame of a first filter according to an embodiment;

FIG. 11 is a bottom view of a second filter according to an embodiment;

FIG. 12 is a perspective view of the second filter according to an embodiment;

FIG. 13 is a side view of the second filter according to an embodiment;

FIG. 14 is a view for explaining a state in which the inlet grill, the first filter, and the second filter are mounted on a base panel and a filter housing;

FIG. 15 is a view for explaining a state in which a disposition of the inlet grill in FIG. 14 is changed;

FIG. 16 is a view for explaining a state in which a disposition of the first filter in FIG. 15 is changed; and

FIG. 17 is a view for explaining a state in which a disposition of the second filter in FIG. 16 is changed.

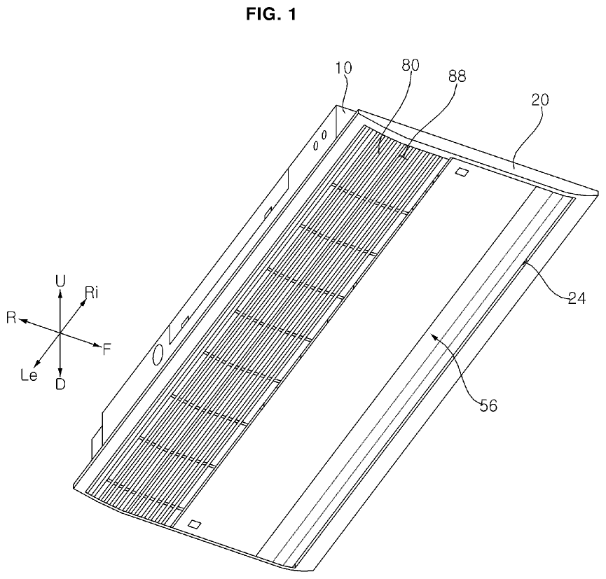

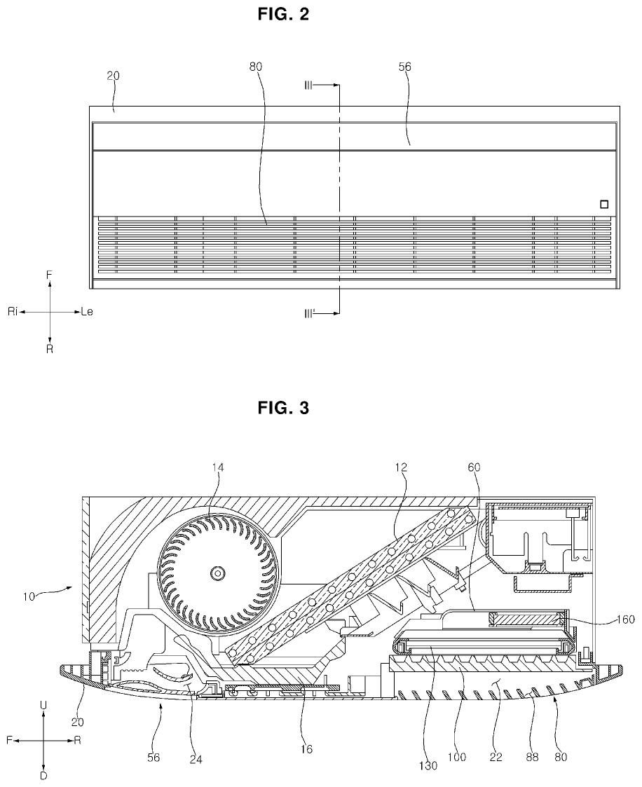

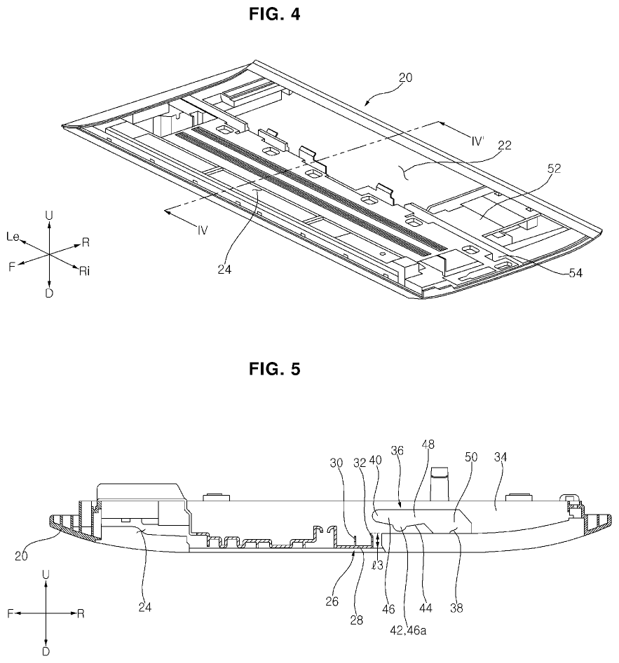

### DETAILED DESCRIPTION

Advantages and features of embodiments and methods of achieving them will become apparent with reference to the embodiments described hereinafter in conjunction with the accompanying drawings. However, embodiments are not limited to the embodiments disclosed hereinafter, but may be implemented in various different forms, and these embodiments are provided only to allow the disclosure to be complete, and to completely inform those of ordinary skill in the art to which the embodiments belong, the scope, and the embodiments are only defined by the scope of the claims. Like reference numerals refer to like elements throughout.

Hereinafter, an air conditioner according to embodiments will be described with reference to drawings.

An air conditioner according to embodiments may include a case 10 forming a space in which a heat exchanger 12 and a fan 14 may be disposed, a base panel 20 that is disposed in a lower side of the case 10 and forms an inlet 22 and an outlet 24, an inlet grill 80 that is rotatably disposed in the base panel 20 and disposed to cover the inlet 22, and a first filter 100 that is detachably disposed in the base panel 20 and removes foreign substances in air flowing into the inlet 22. The air conditioner may include a filter housing 60 disposed in or at an upper side of the base panel 20, a second filter 130 detachably disposed in the filter housing 60, and a deodorization filter 160 disposed in the housing 60 at an upper side of the second filter 130.

The case 10 forms a space in which the fan 14 or the heat exchanger 12 is disposed, and has a structure open downward. The fan 14, which may be referred to as a “drain fan”, collects condensed water generated in the heat exchanger 12 and is disposed in the inner space of the case 10.

The base panel 20 is disposed in or at the lower side of the case 10. The inlet 22 through which air flows into the case 10 and the outlet 24 through which heat-exchanged air is discharged are formed in the base panel 20. The inlet 22 may be spaced apart from the outlet 24 in a frontward-rearward direction.

A vane 56 that adjusts a wind direction of air discharged to the outlet 24 may be disposed in the base panel 20.

The inlet grill 80 disposed in or at the lower side where the inlet 22 is formed may be disposed in the base panel 20. The inlet grill 80 may be larger than the inlet 22. A grill mounting portion 52 in which the inlet grill 80 may be mounted may be formed in the base panel 20. The grill mounting portion 52 may be disposed in or at a lateral side of the inlet 22 and form a space in which the inlet grill 80 is disposed. A guide protrusion groove 54 into which a guide protrusion 94 of the inlet grill 80 described hereinafter may be inserted may be formed in the grill mounting portion 52.

A grill hanger 26 in which a grill holder 90 of the inlet grill 80 described hereinafter may be mounted may be formed in the base panel 20. Referring to FIG. 5, the grill hanger 26 may be disposed in front of the inlet 22.

Referring to FIG. 5, the grill hanger 26 may include a bottom plate 28 on which the grill holder 90 is seated, a first stopper 30 that restricts movement of a first side of the grill holder 90, and a second stopper 32 that restricts movement of a second side of the grill holder 90. A shaft 92 of the grill holder 90 described hereinafter may be disposed in the bottom plate 28. The first stopper 30 may restrict forward movement of the shaft 92. The second stopper 32 may restrict rearward movement of the shaft 92. A rib groove (not shown) through which a first vertical rib 90a of the grill holder 90 described hereinafter passes may be formed in the second stopper 32.

The base panel 20 may further include an inner side wall 34 that extends upward from the lateral ends of the inlet 22. A first guide groove 36 into which a shaft protrusion 122 of the first filter 100 described hereinafter may be inserted may be formed in the inner sidewall 34.

Referring to FIG. 5, the first guide groove 36 has a structure formed in the frontward-rearward direction on the inner side wall 34. An opening 38 into which the shaft protrusion 122 may be inserted may be formed in a rear portion of the first guide groove 36. The opening 38 may have a structure open in a downward direction.

The shaft protrusion 122 may be inserted through the opening 38 formed in the rear portion of the first guide groove 36. The shaft protrusion 122 inserted into the first guide groove 36 through the opening 38 may move forward.

The first guide groove 36 may include a front end portion 40 for positioning the shaft protrusion 122 so that the first filter 100 is mounted in the base panel 20, a shaft groove 42 for positioning the shaft protrusion 122 to maintain the disposition of the first filter 100 when the first filter 100 is dismounted from the base panel 20, and a bump 44 for restricting the movement of the shaft protrusion 122 of the first filter 100 moving to the rear of the shaft groove 42. A state in which the first filter 100 is mounted on the base panel 20 means a state in which the first filter 100 is disposed to filter out foreign substances in air flowing into the inlet 22 of the base panel 20.

When the shaft protrusion 122 is disposed in the front end portion 40, the first filter 100 may be set to be positioned at a first position P21. When the shaft protrusion 122 is disposed in the shaft groove 42, the first filter 100 may be set to be positioned at a second position P22.

In the first guide groove 36, a lower line forming a guide groove may be inclined downward toward the shaft groove 42 from the front end portion 40. Accordingly, when the first filter 100 is detached from the base panel 20, the shaft protrusion 122 may move naturally from the first position P21 to the second position P22. However, the shaft protrusion 122 moving rearward from the first position P21 may be maintained at the second position P22 by the bump 44.

The first guide groove 36 may further include a first sliding groove 46 in which a space in which the groove expands in the upward-downward direction as it progresses from the front end portion 40 toward a rear, a first bending groove 48 in which the space in which the groove is formed is reduced in the upward-downward direction as it progresses from the first sliding groove 46 toward the rear, and an opening groove portion 50 in which the space in which the groove is formed expands in the upward-downward direction as it progresses from the first bending groove 48 toward the rear, and which has the opening 38 formed at a lower side.

The first sliding groove 46 may have a structure in which a height of a lower end portion is deformed while maintaining a height of an upper end portion. Therefore, the first sliding groove 46 may form a structure in which the height of the lower end portion decreases as it progresses from the front to the rear.

The first bending groove 48 may have a structure in which the height of the lower end portion is deformed while maintaining the height of the upper end portion. Accordingly, the first bending groove 48 may form a structure in which the height of the lower end portion increases as it progresses from the front to the rear.

Referring to FIG. 5, the shaft groove 42 may be disposed more rearward than the grill hanger 26. Referring to FIG. 5, the front end portion 40 of the first guide groove 36 may be disposed at an upper side of the grill hanger 26.

A first hook groove (not shown) into which a grill hook 96 of the inlet grill 80 may be inserted may be formed in the base panel 20. A second hook groove (not shown) into which a filter hook 126 of the first filter 100 may be inserted may be formed in the base panel 20.

The filter housing 60 may be disposed in or at the upper side of the base panel 20. In the filter housing 60, the second filter 130 and the deodorization filter 160 may be disposed in or at the upper side of the base panel 20. The filter housing 60 may be disposed in or at the upper side of the inlet 22 of the base panel 20. The filter housing 60 forms a space in which the second filter 130 or the deodorization filter 160 is disposed. The filter housing 60 may have a substantially square frame shape, and may form a space in which the second filter 130 and the deodorization filter 160 are mounted.

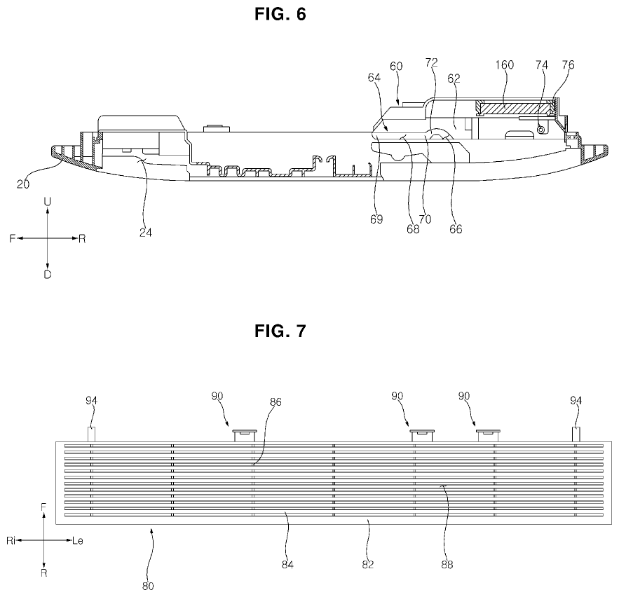

A second guide groove 64 into which a fixing protrusion 148 of the second filter 130 described hereinafter may be inserted may be formed in both side walls 62 of the filter housing 60. Referring to FIG. 6, the second guide groove 64 extends in the frontward-rearward direction. An insertion hole 66 that is open downward so that the fixing protrusion 148 may be inserted may be formed in a rear end portion of the second guide groove 64.

The second guide groove 64 may include a second sliding groove 68 that extends in the frontward-rearward direction and a second bending groove 72 bent upward from the rear of the second sliding groove 68. The insertion hole 66 may be disposed at a rear of the second bending groove 72. The second sliding groove 68 may have a straight line extending in the frontward-rearward direction. The second sliding groove 68 may be disposed parallel to the ground or a ceiling surface. The second sliding groove 68 may have a shape inclined downward as it progresses toward the rear. The second bending groove 72 may extend from a rear end portion 70 of the second sliding groove 68, and may restrict rearward movement of the fixing protrusion 148. The second guide groove 64 formed in the filter housing 60 may be disposed at an upper side of the first guide groove 36 formed in the base panel 20.

Referring to FIG. 6, the second bending groove 72 may be disposed rearward of the bump 44 formed in the first guide groove 36 of the base panel 20. Referring to FIG. 6, the rear end portion 70 of the second sliding groove 68 may be disposed rearward than the shaft groove 42. Referring to FIG. 6, the rear end portion 70 of the second sliding groove 68 may be disposed more rearward than a rear end portion 46a of the first sliding groove 46.

Inner protrusions 74 that protrude inward from both side walls 62 of the filter housing 60 may be disposed in the filter housing 60 to maintain a state in which the second filter 130 is mounted in the filter housing 60. The inner protrusions 74 may be disposed in or at a rear side of the filter housing 60. When the second filter 130 is mounted in the filter housing 60, a hook body 154 of the second filter 130 described hereinafter may be caught on the inner protrusion 74 to fix the disposition. That is, when the second filter 130 is mounted in the filter housing 60, the inner protrusion 74 may be inserted into a second button hole 146 of the second filter 130. A state in which the second filter 130 is mounted in the filter housing 60 may mean a state in which the inner protrusion 74 is caught on a filter handle 138, 140 of the second filter 130 so that the disposition of the second filter 130 may be maintained.

The second filter 130 may be disposed at a front end portion 69 of the second sliding groove 68 or in or at the rear end portion 70 of the second sliding groove 68. When the fixing protrusion 148 is positioned in the front end portion 69 of the second sliding groove 68, the second filter 130 may be positioned in a first position P31. When the fixing protrusion 148 is positioned in the rear end portion 70 of the second sliding groove 68, the second filter 130 may be positioned in a second position P32. When the second filter 130 moves rearward from the first position P31, the disposition in the second position P32 may be maintained by the second bending groove 72.

A filter mounting portion 76 to which the deodorization filter 160 may be mounted may be disposed in the filter housing 60. The filter mounting portion 76 may be disposed in or at an upper side of the second guide groove 64 of the filter housing 60. The filter mounting portion 76 may be disposed more rearward than the second guide groove 64 of the filter housing 60. The filter mounting portion 76 may be disposed more rearward than the second sliding groove 68 of the second guide groove 64 of the filter housing 60. Accordingly, the deodorization filter 160 may be withdrawn from the filter housing 60 in a state in which the fixing protrusion 148 of the second filter 130 is disposed in the second position P32.

The filter housing 60 may be formed as one body with the base panel 20. Accordingly, the first guide groove 36 and the second guide groove 64 may be disposed vertically on the inner sidewall 34 of the base panel 20.

Hereinafter, an inlet grill according to an embodiment will be described with reference to FIGS. 7 to 9.

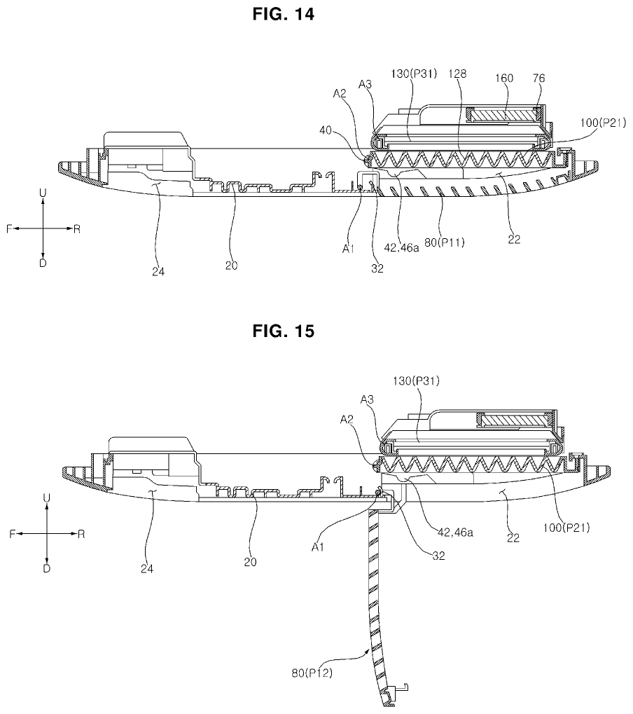

Directions of up (U), down (D), left (Le), right (Ri), front (F), and rear (R) of inlet grill 80 described hereinafter are set based on a state in which the inlet grill 80 is mounted in the base panel 20. The state in which the inlet grill 80 is mounted in the base panel 20 may mean a state in which the inlet grill 80 covers the inlet 22, as shown in FIG. 14. The state in which the inlet grill 80 is mounted in the base panel 20 may be a state in which the grill hook 96 of the inlet grill 80 described hereinafter is inserted into the base panel 20.

The inlet grill 80 may include a plurality of first ribs 84 that extends in a lateral direction and is spaced apart in the frontward-rearward direction and a plurality of second ribs 86 disposed perpendicularly to each of the plurality of first ribs 84. A suction hole 88 through which air flows into the inlet 22 is formed between the plurality of first ribs 84. The plurality of first ribs 84 may have a shape inclined upward in a forward direction. Accordingly, air flowing through the suction hole 88 may flow toward a front side due to the plurality of first ribs 84. A separation distance between the plurality of first ribs 84 may be smaller than a separation distance between the plurality of second ribs 86.

The inlet grill 80 may further include a cover plate 82 that is disposed in or at a lower side of the inlet 22 and has a plurality of suction holes 88 formed therein, a grill holder 90 that is disposed in or at one side of the cover plate 82 and disposes the cover plate 82 in or at one side of the base panel 20, guide protrusion 94 that guides movement of the cover plate 82 rotating from the base panel 20, and grill hook 96 that fixes the cover plate 82 to the base panel 20.

The cover plate 82 may include the plurality of first ribs 84 and the plurality of second ribs 86. The grill holder 90 may be disposed at a front end portion of the cover plate 82. The grill holder 90 may be disposed in the grill hanger 26 of the base panel 20.

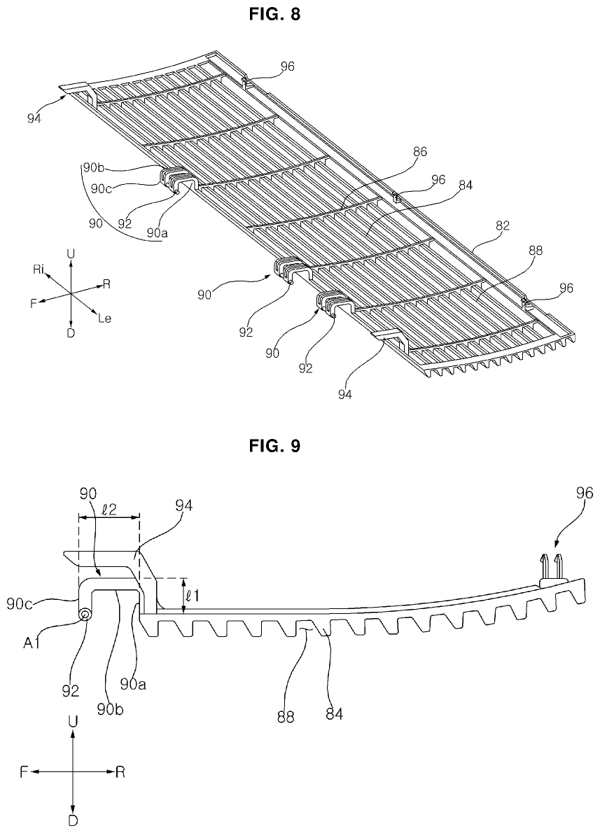

Referring to FIGS. 7 to 8, the inlet grill 80 may include a plurality of grill holders 90 spaced apart in the lateral direction. Each grill holder 90 may extend outward from the cover plate 82. When viewed from the side, the grill holder 90 may have a ‘c’ shape. Shaft 92 forms a rotational shaft that rotates the inlet grill 80 may be disposed at a distal end of the grill holder 90. The shaft 92 has a structure that extends in the lateral direction. A first rotational shaft A1 in which the inlet grill 80 rotates may be formed in a direction in which the shaft 92 extends.

The grill holder 90 may include a first vertical rib 90a that protrudes upward from one side of the inlet grill 80, a horizontal rib 90b that is bent at an upper end portion of the first vertical rib 90a and extends in a direction away from the inlet grill 80, a second vertical rib 90c that is bent at a distal end of the horizontal rib 90b and extends downward, and shaft 92 that is disposed in or at a lower end portion of the second vertical rib 90c and extends in the lateral direction. Referring to FIG. 7, the grill holder 90 may include a pair of first vertical ribs 90a spaced apart in the lateral direction, a pair of horizontal ribs 90b, and a pair of second vertical ribs 90c. Each of the pair of second vertical ribs 90c may be connected to a shaft 92 that extends in the lateral direction.

Referring to FIG. 9, a length 11 of the first vertical rib 90a or the second vertical rib 90c is shorter than a length 12 of the horizontal rib 90b. The length 11 of the first vertical rib 90a or the second vertical rib 90c may be longer than a length 13 of the second stopper 32 formed in the base panel 20 (see FIG. 5).

The shaft 92 may be movably disposed in the base panel 20. The shaft 92 may be rotatably disposed in the base panel 20. The shaft 92 may be moved in the frontward-rearward direction or rotated while being disposed in the grill hanger 26 formed in the base panel 20.

The inlet grill 80 may include guide protrusion 94 that guides rotation of the cover plate 82. The guide protrusion 94 may be disposed more adjacent to lateral outer edges of the inlet grill 80 than the grill holder 90. The guide protrusion 94 may prevent the inlet grill 80 from moving in the lateral direction when the inlet grill 80 rotates.

The inlet grill 80 may include the grill hook 96 that maintains the state in which the inlet grill 80 is mounted in the base panel 20. The grill hook 96 may be disposed opposite to the grill holder 90. Referring to FIGS. 8 to 9, the grill hook 96 may be disposed in or at the rear end portion of the inlet grill 80. The inlet grill 80 may include a plurality of grill hooks 96 spaced apart in the lateral direction. Referring to FIGS. 8 to 9, a plurality of grill hooks 96 may be disposed at regular intervals in the frontward-rearward direction.

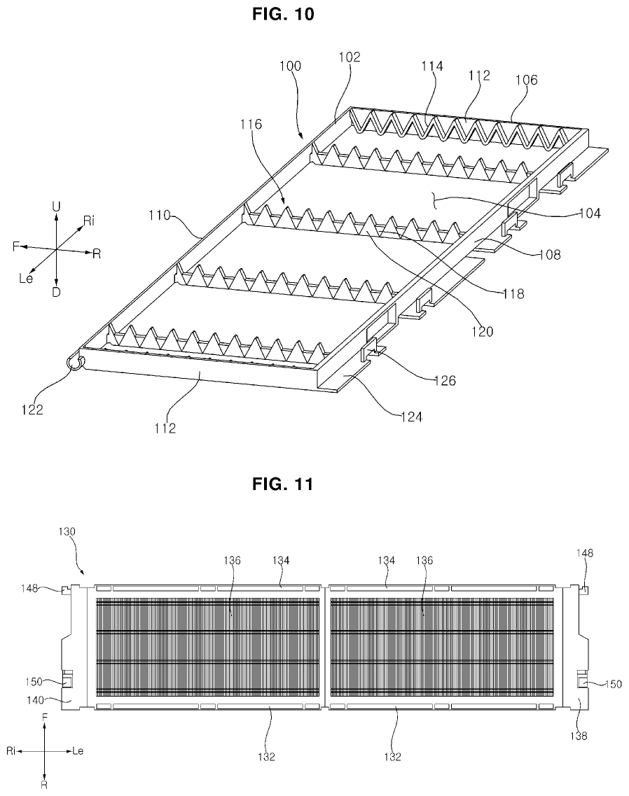

Hereinafter, a first filter according to an embodiment will be described with reference to FIG. 10.

Directions of up (U), down (D), left (Le), right (Ri), front (F), and rear (R) of first filter 100 described hereinafter are set based on a state in which the first filter 100 is mounted in the base panel 20. The state in which the first filter 100 is mounted in the base panel 20 may mean a state in which the first filter 100 is disposed in the inlet 22, as shown in FIG. 14. The state in which the first filter 100 is mounted in the base panel 20 may mean a state in which the grill hook 96 of the first filter 100 described hereinafter is inserted into the base panel 20. The state in which the first filter 100 is mounted in the base panel 20 may mean a state in which the shaft protrusion 122 of the first filter 100 described hereinafter is disposed in or at the front end portion 40 of the first guide groove 36 formed in the base panel 20.

The first filter 100 may include a filter frame 102 and a filter net 128 (see FIG. 14). The first filter 100 may be a pre-filter that primarily filters foreign substances in air passing through the inlet grill 80. The filter frame 102 may include an outer frame 106 forming an air flow hole 104 therein, an inner frame 116 that is disposed inside of the outer frame 106 and supports the disposition of the filter net 128, a shaft protrusion 122 that extends to the outside of the outer frame 106 and forms a shaft around which the first filter 100 rotates, and filter hook 126 that maintains the state in which the first filter 100 is mounted in the base panel 20.

The first filter 100 is disposed to cover the inlet 22 formed in the base panel 20. Thus, air passing through the inlet 22 may pass through the first filter 100.

The filter frame 102 may have a rectangular frame shape to be disposed in the inlet 22. The filter frame 102 may include a pair of side walls 112 spaced apart in the lateral direction, a front wall 108 disposed in or at a front end portion of each of the pair of side walls 112, and a rear wall 110 disposed in or at a rear end portion of each of the pair of side walls 112.

A pair of shaft protrusions 122 that protrudes in an outward direction are disposed in or at the front end portion of each of the pair of side walls 112. The outward direction may mean a direction to which an outer circumferential surface of each of the pair of side walls 112 faces. A support rib 114 that supports the disposition of the filter net 128 disposed in a zigzag pattern may be disposed on an inner circumferential surface of each of the pair of side walls 112.

The inner frame 116 has a structure that extends in the frontward-rearward direction from inside of the outer frame 106. A plurality of inner frames 116 spaced apart in the lateral direction inside of the outer frame 106 may be provided.

Each of the plurality of inner frames 116 may be connected to the front wall 108 at a first side and to the rear wall 110 at a second side. Each of the plurality of inner frames 116 may include a frame bar 118 that extends in the frontward-rearward direction, and a filter net fixing rib 120 that maintains a shape of the filter net 128 disposed in the frame bar 118. The filter net fixing rib 120 may have a shape corresponding to the support rib 114. The filter net fixing rib 120 may maintain the filter net 128 disposed inside of the filter frame 102 to be disposed in a zigzag pattern in the frontward-rearward direction.

The shaft protrusion 122 may rotate the first filter 100 while being disposed in the first guide groove 36 of the base panel 20. The shaft protrusion 122 may act as a rotational shaft around which the first filter 100 rotates. Referring to FIG. 10, the shaft protrusion 122 may have a structure that extends in an outward direction from both end portions of the front wall 108.

The shaft protrusion 122 may be inserted into the opening 38 of the first guide groove 36 formed in the base panel 20. The shaft protrusion 122 may be disposed in the front end portion 40 or the shaft groove 42 of the first guide groove 36 formed in the base panel 20.

The filter hook 126 may be disposed in or at a rear of the first filter 100. Referring to FIG. 10, the filter hook 126 may be disposed more rearward than the rear wall 110 of the filter frame 102. The filter hook 126 may be rearwardly spaced from the rear wall 110. Referring to FIG. 10, the filter hook 126 may be disposed in a spacing plate 124 that extends rearward from the rear wall 110. The filter hook 126 may have a structure protruding upward from the spacing plate 124. The filter hook 126 may be inserted into a second hook groove of the base panel 20 to fix the disposition of the first filter 100.

The filter net 128 may be disposed in a zigzag pattern in the filter frame 102. Therefore, a removal performance of foreign matter in the air may be enhanced by increasing a contact area with the air flowing into the inlet 22.

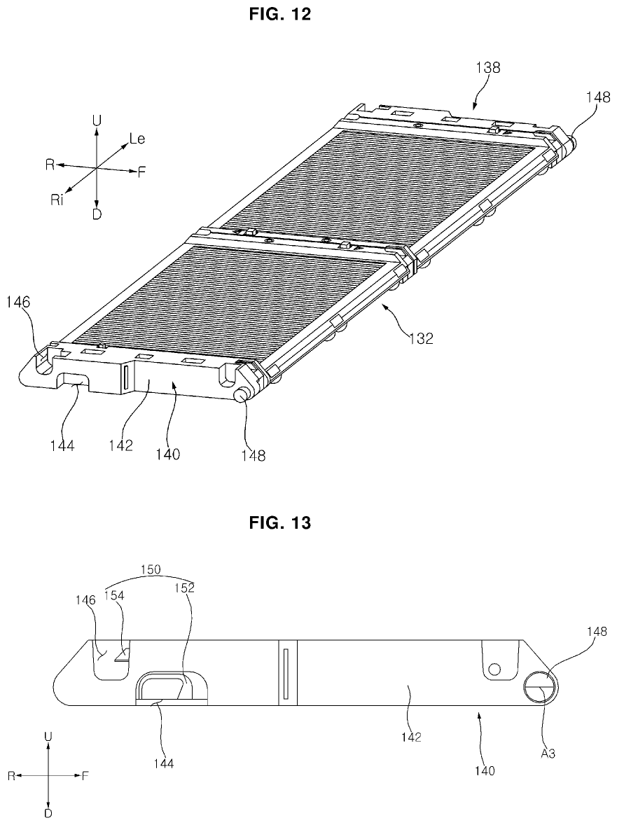

Hereinafter, a second filter according to an embodiment will be described with reference to FIGS. 11 to 13.

Directions of up (U), down (D), left (Le), right (Ri), front (F), and rear (R) of second filter 130 described hereinafter are set based on a state in which the second filter 130 is mounted in the filter housing 60. The state in which the second filter 130 is mounted in the filter housing 60 may mean a state in which the second filter 130 is disposed in the inlet 22, as shown in FIG. 14. The state in which the second filter 130 is mounted in the filter housing 60 may be a state in which the second filter 130 described hereinafter is disposed parallel to the first filter 100 in the upper side of the first filter 100.

The second filter 130 may be, for example, an electric dust collector that secondarily filters foreign substances in the air that passed through the first filter 100. The second filter 130 may include at least one filter body 132 that collects dust particles in the air, a first filter handle 138 that is disposed at a first side of the filter body 132 and fixes the disposition of the filter body 132 to the filter housing 60, and a second filter handle 140 that is disposed at a second side of the filter body 132 and fixes the disposition of the filter body 132 to the filter housing 60.

A plurality of filter bodies 132 may be disposed between the first filter handle 138 and the second filter handle 140. The filter body 132 may include a filter case 134 that forms an outer shape and is opened to allow air to flow in a heightwise direction of the filter body 132, and a plurality of electric dust collection films 136 that is spaced apart from each other inside of the filter case 134 and collects dust particles in the air.

The second filter 130 may include first filter handle 138 and second filter handle 140. The first filter handle 138 and the second filter handle 140 may have a symmetrical structure in the lateral direction.

Each of the first filter handle 138 and the second filter handle 140 may include a handle cover 142 connected to the filter body 132, a fixing protrusion 148 that is disposed in or at one side of the handle cover 142 and caught on the filter housing 60, and a filter button 150 that fixes the handle cover 142 to the filter housing 60 or releases the handle cover 142 from the filter housing 60.

Referring to FIG. 13, the fixing protrusion 148 may be disposed in or at a front of the handle cover 142, and the filter button 150 may be disposed in or at a rear of the handle cover 142.

In the handle cover 142, a first button hole 144 that is formed in a lower surface of the handle cover 142 and exposes some components of the filter button 150, and second button hole 146 that is formed in an upper surface of the handle cover 142 and exposes other components of the filter button 150 may be formed. A press body 152 of the filter button 150 may be disposed in the first button hole 144. Hook body 154 of the filter button 150 may be disposed in the second button hole 146. The press body 152 and the hook body 154 may be formed as one body, so that the disposition may be changed identically. Therefore, when a user applies pressure to the press body 152, the disposition of the hook body 154 may also move in a direction in which the press body 152 moves.

The filter button 150 may include an elastic body (not shown) that restores the disposition of the press body 152 when no external force is applied to the press body 152. When no external force is applied to the press body 152, the disposition of the press body 152 and the hook body 154 may be determined by the elastic body. That is, the elastic body may be disposed inside of the handle cover 142, and may maintain the disposition of the press body 152 and the hook body 154. When only the elastic body applies force to the press body 152, the hook body 154 may be disposed to be caught on one side of the filter housing 60. Therefore, the hook body 154 is disposed in or at an upper side of the inner protrusion 74, so that the second filter 130 may be fixedly disposed inside of the filter housing 60.

However, when a user, for example, presses the press body 152, the disposition of the hook body 154 may be changed. When the press body 152 is applied with a pressure in an opposite direction to the elastic force of the elastic body, the hook body 154 may be released. When the press body 152 is applied with a pressure in the opposite direction to the elastic force of the elastic body, the hook body 154 is not disposed in the upper side of the inner protrusion 74, so that one side of the second filter 130 may be released from the filter housing 60.

The second filter 130, when viewed from the side, may have a trapezoidal shape in which a length in the frontward-rearward direction becomes narrower toward an upper side. Accordingly, it may be freely rotated in the downward direction of the filter housing 60 based on the fixing protrusion 148.

In the second filter 130, the filter body 132, the first filter handle 138, and the second filter handle 140 may be formed as one body. Accordingly, the filter body 132 may include each of the first filter handle 138 and the second filter handle 140. Accordingly, the fixing protrusion 148 may be formed at both sides of the filter body 132, and the filter button 150 fixed to the filter housing 60. In addition, the filter case 134 may include handle cover 142 for each of the first filter handle 138 and the second filter handle 140. The fixing protrusions 148 may be formed at both sides of the filter case 134, and the filter button 150 fixed to the filter housing 60.

Hereinafter, the inlet grill 80, the first filter 100, and the second filter 130 whose dispositions are changed will be described with reference to FIGS. 14 to 17. Referring to FIG. 14, each of the inlet grill 80, the first filter 100, and the second filter 130 may be mounted in the base panel 20 or the filter housing 60. Referring to FIG. 14, the inlet grill 80 may be disposed below the inlet 22 to cover the inlet 22. The inlet grill 80 may be disposed in first position P11 of the inlet grill 80 in which the grill hook 96 is mounted in the first hook groove of the base panel 20.

At the first position P11 of the inlet grill 80, the shaft 92 of the inlet grill 80 may be spaced forward from the second stopper 32. At the first position P11 of the inlet grill 80, the grill hook 96 of the inlet grill 80 may be inserted into the first hook groove of the base panel 20. At the first position P11 of the inlet grill 80, the inlet grill 80 may be disposed substantially parallel to the ground.

Referring to FIG. 14, the first filter 100 may be disposed to filter out foreign substances in the air flowing through the inlet 22. The first filter 100 may be disposed in first position P21 of the first filter 100 where the filter hook 126 is inserted into the second hook groove of the base panel 20.

At the first position P21 of the first filter 100, the shaft protrusion 122 of the first filter 100 may be disposed in the front end portion 40 of the first guide groove 36. At the first position P21 of the first filter 100, the filter hook 126 of the first filter 100 may be inserted into the second hook groove of the base panel 20. When the first filter 100 is disposed in the first position P21, the air flowing into the inlet 22 may flow upward through the first filter 100. At the first position P21 of the first filter 100, the first filter 100 may be disposed substantially parallel to the ground.

Referring to FIG. 14, the second filter 130 may be disposed to filter out foreign substances in the air flowing through the inlet 22. The second filter 130 may be disposed in first position P31 of the second filter 130 where the hook body 154 of the filter button 150 is disposed above the inner protrusion 74 of the filter housing 60.

At the first position P31 of the second filter 130, the fixing protrusion 148 of the second filter 130 is disposed in the front end portion 69 of the second guide groove 64. At the first position P31 of the second filter 130, the second filter 130 may be maintained fixed to the filter housing 60 by the hook body 154 of the second filter 130. The second filter 130 may remove foreign substances in the air flowing upward through the inlet 22 at the first position P31. At the first position P31 of the second filter 130, the second filter 130 may be disposed substantially parallel to the ground.

Referring to FIG. 14, in a state in which each of the inlet grill 80, the first filter 100, and the second filter 130 is mounted in the base panel 20 or the filter housing 60, the air flowing into the case 10 may sequentially pass through the inlet grill 80, the first filter 100, and the second filter 130. Referring to FIG. 15, each of the first filter 100 and the second filter 130 is mounted in the base panel 20 or filter housing 60, and the inlet grill 80 may maintain a state of being caught on the base panel 20. The state in which the inlet grill 80 is caught on the base panel 20 may mean a state in which the grill hook 96 of the inlet grill 80 is separated from the first hook groove of the base panel 20.

Referring to FIG. 15, the disposition of the first filter 100 and the second filter 130 is the same as that of FIG. 14. Referring to FIG. 15, the grill holder 90 of the inlet grill 80 is disposed above the grill hook 96. The inlet grill 80 may be disposed in the second position P12 of the inlet grill 80 where the grill hook 96 is separated from the first hook groove of the base panel 20.

At the second position P12 of the inlet grill 80, the shaft 92 of the inlet grill 80 may be disposed to contact the second stopper 32. That is, when the inlet grill 80 is changed from the first position P11 to the second position P12, the shaft 92 formed along first rotational shaft A1 may move rearward. At the second position P12 of the inlet grill 80, the grill hook 96 of the inlet grill 80 may be separated from the first hook groove of the base panel 20.

At the second position P12 of the inlet grill 80, the inlet grill 80 may be disposed forward than the shaft groove 42 of the first guide groove 36. At the second position P12 of the inlet grill 80, the inlet grill 80 may be disposed substantially perpendicular to the ground.

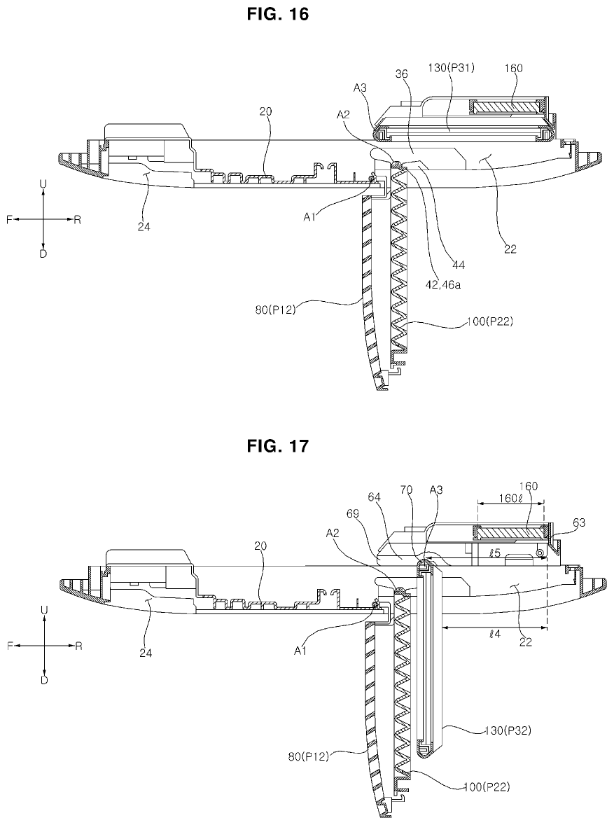

Referring to FIG. 16, the second filter 130 is mounted in the base panel 20 or the filter housing 60, and the first filter 100 and the inlet grill 80 may maintain a state of being caught on the base panel 20. The state in which the first filter 100 is caught on the base panel 20 may mean a state in which the filter hook 126 of the first filter 100 is separated from the first hook groove of the base panel 20.

Referring to FIG. 16, the disposition of the second filter 130 is the same as that of FIG. 15. Referring to FIG. 16, the disposition of the inlet grill 80 is the same as that of FIG. 15.

Referring to FIG. 16, the shaft protrusion 122 of the first filter 100 is disposed above the filter hook 126. The first filter 100 may be disposed in the second position P22 of the first filter 100 where the filter hook 126 is separated from the second hook groove of the base panel 20.

At the second position P22 of the first filter 100, the shaft protrusion 122 of the first filter 100 may be disposed in the shaft groove 42 of the first guide groove 36. At the second position P22 of the first filter 100, the shaft protrusion 122 of the first filter 100 may be disposed in or at the rear end portion 46a of the first sliding groove 46. That is, when the first filter 100 is changed from the first position P11 to the second position P12, the shaft protrusion 122 forming second rotational shaft A2 may move from the front end portion 40 of the first guide groove 36 to the shaft groove 42.

When the first filter 100 is changed from the first position P21 to the second position P22, the shaft protrusion 122 forming the second rotational shaft A2 may move from the front end portion 40 of the first sliding groove 46 to the rear end portion 46a. At the second position P22 of the first filter 100, the filter hook 126 of the first filter 100 may be separated from the second hook groove of the base panel 20.

At the second position P22 of the first filter 100, the first filter 100 may be disposed more rearward than the inlet grill 80. Therefore, even if each of the inlet grill 80 and the first filter 100 is maintained in a state of being caught on the base panel 20, interference between the dispositions of the inlet grill 80 and the first filter 100 does not occur. At the second position P22 of the first filter 100, the first filter 100 may be disposed substantially perpendicular to the ground.

Referring to FIG. 17, each of the inlet grill 80, the first filter 100, and the second filter 130 may maintain a state of being caught on the base panel 20 or the filter housing 60. The state in which the second filter 130 is caught on the base panel 20 or the filter housing 60 may mean a state where the hook body 154 of the second filter 130 is separated from the inner protrusion 74 of the filter housing 60.

Referring to FIG. 17, the disposition of the inlet grill 80 and the first filter 100 is the same as that of FIG. 16. Referring to FIG. 17, the fixing protrusion 148 of the second filter 130 is disposed above the filter button 150. In the first filter 100, the filter button 150 may be disposed from the inner protrusion 74 of the filter housing 60 to the second position P32 of the second filter 130.

At the second position P32 of the second filter 130, the fixing protrusion 148 of the second filter 130 may be disposed in or at the rear end portion 70 of the second sliding groove 68. At the second position P32 of the second filter 130, the fixing protrusion 148 of the second filter 130 may be disposed in front of the second bending groove 72. That is, when the second filter 130 is changed from the first position P31 to the second position P32, the protrusion 148 forming third rotational shaft A3 may move rearward from the front end portion 69 of the second guide groove 64. When the second filter 130 is changed from the first position P31 to the second position P32, the fixing protrusion 148 forming the third rotational shaft A3 may move from the front end portion 69 to the rear end portion 70 of the second sliding groove 68.

At the second position P32 of the second filter 130, the filter button 150 of the second filter 130 may be separated from the second hook groove of the base panel 20. At the second position P32 of the second filter 130, the second filter 130 may be disposed rearward than the first filter 100 or the inlet grill 80. Therefore, even if each of the inlet grill 80, the first filter 100, and the second filter 130 is maintained in a state of being caught on the base panel 20 or the filter housing 60, interference between the dispositions of the inlet grill 80, the first filter 100, and the second filter 130 does not occur. At the second position P32 of the second filter 130, the second filter 130 may be disposed substantially perpendicular to the ground.

Referring to FIG. 17, at the second position P32 of the second filter 130, a distance 14 between the second filter 130 and the rear wall 63 of the filter housing 60 is formed longer than a length 1601 of the deodorization filter 160 formed in the frontward-rearward direction. Referring to FIG. 17, a distance 15 between the rear end portion 70 of the second sliding groove 68 formed in the filter housing 60 and the rear wall 63 of the filter housing 60 is formed longer than the length 1601 of the deodorization filter 160 formed in the frontward-rearward direction.

The air conditioner according to embodiments disclosed herein provides one or more of the following advantages.

First, it has a structure in which the rotational shaft of the filter disposed in or at the upper side of the inlet grill can move, so that the filter may be easily mounted on the base panel through sliding and rotation of the filter.

Second, it has a structure in which the first filter disposed in or at the upper side of the inlet grill can rotate while moving along the sliding groove, so that the first filter may be separated or coupled to the base panel by moving and rotating the first filter while the inlet grill is rotated. This has the advantage that the first filter may be separated or coupled without separating the inlet grill from the base panel.

Third, a moving area and range of the rotational shaft of each of the first filter and the second filter disposed in or at the upper side of the inlet grill are different, so that the second filter may be moved and rotated while the first filter is caught on the base panel to move upward, thereby being separated or coupled to the upper side of the base panel. This has the advantage that the second filter may be separated or coupled without separating the inlet grill or the first filter from the base panel.

Fourth, it has a structure in which the deodorizing filter disposed in or at the upper side may be exposed while the second filter is rotated, so that only the deodorizing filter may be separately separated or coupled while the first or second filter is caught on the base panel.

Embodiments disclosed herein provide an air conditioner for which it is easy to replace an inlet grill or a filter of an air conditioner installed at a high position. Embodiments disclosed herein further provide an air conditioner for which it is easy to separate a plurality of filters disposed inside of the air conditioner without separating an inlet grill. Embodiments disclosed herein furthermore provide an air conditioner for which it is easy to individually separate a plurality of filters disposed inside of an air conditioner.

Embodiments disclosed herein provide an air conditioner that may include a case; a base panel which is disposed in one side of the case, and has an inlet into which air flows; an inlet grill which is rotatably disposed in the base panel based on a first rotational shaft, and disposed in a lower side of the inlet; and a first filter which is movably or rotatably disposed in the base panel based on a second rotational shaft, and removes foreign substances in the air flowing into the inlet. The second rotational shaft of the first filter may be movably disposed in a frontward-rearward direction in or at an upper side of the first rotational shaft of the suction panel, so that the second rotational shaft of the first filter may rotate the first filter by moving rearward from a first rotational shaft around which an inlet grill rotates.

The first rotational shaft and the second rotational shaft may be disposed in parallel. The first rotational shaft may be disposed in front of the inlet. The second rotational shaft may be disposed above the first rotational shaft, and disposed to be movable rearward than the first rotational shaft, so that in a state in which the inlet grill is rotated, the second rotational shaft is moved to rotate the first filter.

A first guide groove that guides movement of the second rotational shaft of the first filter may be formed in the base panel. The first guide groove may have a structure inclined downward as it progresses toward a rear side from a front end portion, so that the first filter may be easily slid rearward.

A shaft groove that is recessed downward to restrict rearward movement of the second rotational shaft of the first filter may be formed in the first guide groove, so that movement of the second rotational shaft of the first filter may be temporarily restricted. The shaft groove may be spaced apart rearward than the first rotational shaft at a certain interval, so that the first filter may rotate in a rear side of the first rotational shaft.

A bump that protrudes upward to restrict rearward movement of the second rotational shaft of the first filter may be disposed in the first guide groove, so that movement of the second rotational shaft of the inlet grill may be temporarily restricted.

The first guide groove may include a first sliding groove in which a space that forms a groove expands in an upward-downward direction as it progresses from a front end portion toward a rear; a first bending groove in which a space that forms a groove is reduced in an upward-downward direction as it progresses from the first sliding groove toward a rear; and an opening groove in which a space that forms a groove extends in an upward-downward direction as it progresses from the first bending groove toward a rear, and which has an opening formed in a lower side, so that the second rotational shaft may move rearward through the first sliding groove, the rearward movement may be temporarily restricted through the first bending groove, and the first filter may be separated from the base panel through an opening groove portion.

The first filter includes a filter frame and a filter net disposed in the filter frame to remove foreign substances in flowing air. The filter frame may include an outer frame that forms an air flow hole therein, an inner frame which is disposed inside of the outer frame and supports a disposition of the filter net, and a shaft protrusion that extends to an outside of the outer frame and extends along the second rotational shaft. The shaft protrusion may move along the first guide groove.

The filter frame may further include a filter hook that maintains the first filter mounted in the base panel. The filter hook may be disposed to be spaced apart from the shaft protrusion in a frontward-rearward direction.

The inlet grill may include a cover plate which is disposed in or at a lower side of the inlet, and has a plurality of suction holes; a grill holder which is disposed in or at one side of the cover plate, and disposes the cover plate in or at one side of the base panel; and a panel hook which fixes the cover plate to the base panel. The grill holder may include a shaft that extends along the first rotational shaft, so that rotation of the shaft may cause the cover plate to rotate.

The grill holder may further include a first vertical rib that protrudes upward from one side of the cover plate; a horizontal rib which is bent at an upper end portion of the first vertical rib and extends in a direction away from the cover plate; and a second vertical rib which is bent at a distal end portion of the horizontal rib and extends downward. The shaft may be disposed at a lower end portion of the second vertical rib and extend in a lateral direction.

A grill hanger in which the grill holder is seated in front of the inlet may be disposed in the base panel, so that the inlet grill may be maintained to be caught on the base panel. The grill hanger may include a bottom plate in which the shaft is seated; a first stopper which restricts movement of one or a first side of the shaft; and a second stopper which restricts movement of the other or a second side of the shaft. A rib groove through which the second vertical rib passes may be formed in the second stopper, so that the second stopper allows movement of the second vertical rib and restricts rearward movement of the shaft.

A length of the first vertical rib or the second vertical rib may be longer than a length of the second stopper, so that in a state where the inlet grill is mounted in the base panel, the horizontal rib may be disposed above the second stopper.

The air conditioner may further include a second filter which is disposed to move or rotate on the base panel or an upper side of the base panel based on a third rotational shaft, and removes foreign substances in the air passed through the first filter, so that a second filter that rotates or moves based on the third rotational shaft may be additionally disposed in the upper side of the first filter.

The third rotational shaft may be disposed parallel to the first rotational shaft or the second rotational shaft. The first rotational shaft may be disposed in front of the inlet, and the third rotational shaft may be disposed above the first rotational shaft and be movable more rearward than the first rotational shaft, so that the second filter may be rotated by moving more rearward than a rotational position of the inlet grill. The third rotational shaft may be disposed above the second rotational shaft, and be movable more rearward than the second rotational shaft, so that the second filter may rotate by moving more rearward than a rotational position of the first filter.

The air conditioner may further include a filter housing which is disposed in or at the upper side of the base panel, and in which the second filter is mounted. A second guide groove that guides movement of the third rotational shaft of the second filter may be formed in both sidewalls of the filter housing, so that the second filter may move or rotate along the second guide grooves in or at the upper side of the first filter.

The second guide groove may include a second sliding groove that extends in a frontward-rearward direction; and a second bending groove having a shape bent upward from a rear side of the second sliding groove, so that the second filter may move through the second sliding groove or be restricted in movement by the second bending groove.

A first guide groove that guides movement of the second rotational shaft of the first filter may be formed in the base panel. The first guide groove may include a first sliding groove in which a space that forms a groove that expands in an upward-downward direction as it progresses from a front end portion toward a rear, and a first bending groove in which a space that forms a groove is reduced in an upward-downward direction as it progresses from the first sliding groove toward a rear. A rear end portion of the second sliding groove may be disposed more rearward than a rear end portion of the first sliding groove, so that the second filter may rotate rearward than an area in which the first filter rotates.

The air conditioner may further include a deodorization filter disposed in or at an upper side of the second filter. The deodorization filter may be disposed in or at a rear side of the filter housing, so that odors in the air passed through the second filter may be removed. A rear end portion of the second sliding groove may be disposed in front of the deodorization filter, so that when the second filter rotates in the rear end portion of the second sliding groove, the deodorization filter may be exposed downward.

Although embodiments have been described with reference to specific embodiments shown in the drawings, it is apparent to those skilled in the art that embodiments are not limited to those exemplary embodiments and may be embodied in many forms without departing from the scope, which is described in the following claims. These modifications should not be individually understood from the technical spirit or scope.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioner, comprising:
a case;
a base panel that is disposed at a first side of the case and has an inlet into which air flows;
an inlet grill that is rotatably disposed in the base panel based on a first rotational shaft; and
a first filter that is movably or rotatably disposed in the base panel based on a second rotational shaft and removes foreign substances in the air flowing into the inlet, wherein the inlet grill is disposed below the first filter, wherein the second rotational shaft of the first filter is movably disposed in a frontward-rearward direction at an upper side of the first rotational shaft of the inlet grill.

2. The air conditioner of claim 1, wherein the first rotational shaft and the second rotational shaft are disposed in parallel, the first rotational shaft is disposed in front of the inlet in a frontward-rearward direction of the air conditioner, and the second rotational shaft is disposed above the first rotational shaft, and is disposed to be movable more rearward than the first rotational shaft.

3. The air conditioner of claim 1, wherein a first guide groove that guides movement of the second rotational shaft of the first filter is formed in the base panel, and wherein the first guide groove is inclined downward as the first guide groove extends toward a rear side from a front end portion.

4. The air conditioner of claim 3, wherein a shaft groove that is recessed downward to restrict rearward movement of the second rotational shaft of the first filter is formed in the first guide groove.

5. The air conditioner of claim 4, wherein the shaft groove is spaced apart more rearward than the first rotational shaft by a predetermined interval.

6. The air conditioner of claim 3, wherein a bump that protrudes upward to restrict rearward movement of the second rotational shaft of the first filter is disposed in the first guide groove.

7. The air conditioner of claim 3, wherein the first guide groove comprises a groove that is formed in an upward-downward direction and extends in a forward and backward direction, wherein the first guide groove comprises:
a first sliding groove in which a space that forms the first guide groove expands in the upward-downward direction as the first sliding groove extends from a front end portion toward a rear;
a first bending groove in which a space that forms the first guide groove is reduced in the upward-downward direction as the first bending groove extends from the first sliding groove toward the rear; and
an opening groove in which a space that forms the first guide groove extends in the upward-downward direction as the opening groove extends from the first bending groove toward the rear, and which has an opening formed in a lower side thereof.

8. The air conditioner of claim 3, wherein the first filter comprises a filter frame and a filter net disposed in the filter frame to remove foreign substances in flowing air, wherein the filter frame comprises an outer frame that forms an air flow hole therein, an inner frame that is disposed inside of the outer frame and supports a disposition of the filter net, and a shaft protrusion that extends to an outside of the outer frame and extends along the second rotational shaft, wherein the shaft protrusion moves along the first guide groove.

9. The air conditioner of claim 8, wherein the filter frame further comprises a filter hook that maintains the first filter mounted in the base panel, and wherein the filter hook is spaced apart from the shaft protrusion in the frontward-rearward direction.

10. The air conditioner of claim 1, wherein the inlet grill comprises:
a cover plate which is disposed at a lower side of the inlet and has a plurality of suction holes;
at least one grill holder that is disposed at a first side of the cover plate, and disposes the cover plate at one side of the base panel; and
a panel hook that fixes the cover plate to the base panel, wherein the at least one grill holder comprises a shaft that extends along the first rotational shaft.

11. The air conditioner of claim 10, wherein the at least one grill holder further comprises:
a first vertical rib that protrudes upward from a first side of the cover plate;
a horizontal rib that is bent at an upper end portion of the first vertical rib and extends in a direction away from the cover plate; and
a second vertical rib that is bent at a distal end portion of the horizontal rib and extends downward, wherein the shaft is disposed at a lower end portion of the second vertical rib and extends in a lateral direction.

12. The air conditioner of claim 11, wherein a grill hanger in which the at least one grill holder is seated in front of the inlet is disposed in the base panel, wherein the grill hanger comprises:
a bottom plate in which the shaft is seated;
a first stopper that restricts movement at a first side of the shaft; and
a second stopper that restricts movement of at second side of the shaft, wherein a rib groove through which the second vertical rib passes is formed in the second stopper.

13. The air conditioner of claim 12, wherein a length of the first vertical rib or the second vertical rib is longer than a length of the second stopper.

14. The air conditioner of claim 1, further comprising a second filter that is movably or rotatably disposed on the base panel or an upper side of the base panel based on a third rotational shaft and removes foreign substances in the air passed through the first filter.

15. The air conditioner of claim 14, wherein the third rotational shaft is disposed parallel to the first rotational shaft or the second rotational shaft, wherein the first rotational shaft is disposed in front of the inlet, and the third rotational shaft is disposed above the first rotational shaft and is movable more rearward than the first rotational shaft.

16. The air conditioner of claim 15, wherein the third rotational shaft is disposed above the second rotational shaft and is movable more rearward than the second rotational shaft.

17. The air conditioner of claim 14, further comprising a filter housing which is disposed at an upper side of the base panel, and in which the second filter is mounted, wherein a second guide groove that guides movement of the third rotational shaft of the second filter is formed in both sidewalls of the filter housing.

18. The air conditioner of claim 17, wherein the second guide groove comprises:
a second sliding groove that extends in a frontward-rearward direction; and
a second bending groove having a shape bent upward from a rear side of the second sliding groove.

19. The air conditioner of claim 18, wherein a first guide groove that guides movement of the second rotational shaft of the first filter is formed in the base panel, wherein the first guide groove comprises a first sliding groove in which a space that forms a groove that expands in an upward-downward direction as the first sliding groove extends from a front end portion toward a rear, and a first bending groove in which a space that forms the groove is reduced in the upward-downward direction as the first bending groove extends from the first sliding groove toward the rear, wherein a rear end portion of the second sliding groove is disposed more rearward than a rear end portion of the first sliding groove.

20. The air conditioner of claim 18, further comprising a deodorization filter disposed at an upper side of the second filter, wherein the deodorization filter is disposed at a rear side of the filter housing, and wherein a rear end portion of the second sliding groove is disposed in front of the deodorization filter.

21. An air conditioner, comprising:
a case;
a base panel that is disposed at a first side of the case and has an inlet into which air flows;
an inlet grill that is rotatably coupled to the base panel based on a first rotational shaft;
a first filter that is movably or rotatably coupled to the base panel based on a second rotational shaft and removes foreign substances in the air flowing into the inlet, wherein the inlet grill is disposed below the first filter, wherein the second rotational shaft of the first filter is movably disposed in a frontward-rearward direction at an upper side of the first rotational shaft of the inlet grill; and
a second filter that is movably or rotatably coupled to the base panel or an upper side of the base panel based on a third rotational shaft and removes foreign substances in the air passed through the first filter, wherein the first rotational shaft is disposed in front of the inlet, and the third rotational shaft is disposed above the first rotational shaft and is movable more rearward than the first rotational shaft.

22. An air conditioner, comprising:
a case;
a base panel that is disposed at a first side of the case and has an inlet into which air flows;
an inlet grill that is rotatably coupled to the base panel based on a first rotational shaft;
a first filter that is rotatably coupled to the base panel based on a second rotational shaft and removes foreign substances in the air flowing into the inlet, wherein the inlet grill is disposed below the first filter, wherein the second rotational shaft of the first filter is movably disposed in a frontward-rearward direction at an upper side of the first rotational shaft of the inlet grill; and
a second filter that is rotatably coupled to the base panel or an upper side of the base panel based on a third rotational shaft and removes foreign substances in the air passed through the first filter, wherein the inlet grill, the first filter, and the second filter are each rotatable between a first horizontally extending position and a second vertically extending position.
